(19) United States
(12) Patent Application Publication
(10) Pub. No.: US 2007/0103827 A1
(43) Pub. Date: May 10, 2007

(54) Liquid crystal display having electrostatic discharge unit

(75) Inventor: Chien-Jen Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/595,502

(22) Filed: Nov. 10, 2006

(30) Foreign Application Priority Data
Nov. 10, 2005 (CN) 200510101212.X

(51) Int. Cl. H02H 9/00

(52) U.S. Cl. 361/56

(57) ABSTRACT

An exemplary liquid crystal display (LCD) (100) includes a thin film transistor (TFT) substrate (12), a driving integrated circuit (IC) (13) disposed on the TFT substrate, a flexible printed circuit board (FPCB) (14) connected to an edge of the TFT substrate, and at least one electrostatic discharge unit (15) provided on the TFT substrate. Each first conducting line includes a first metal pads and a second metal pad at two opposite ends thereof respectively. The driving IC includes a plurality of input/output pins connected to the first metal pads respectively. The FPCB includes a plurality of second conducting lines connected to the first conducting lines via the second metal pads respectively. The at least one electrostatic discharge unit is located and electrically connected between one of the first metal pads and one of the second metal pads, a terminal of the at least one electrostatic discharge unit connected to ground.

### FIELD OF THE INVENTION

The present invention relates to liquid crystal displays, and particularly to a liquid crystal display (LCD) having an electrostatic discharge unit.

### BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace cathode ray tube (CRT) monitors and televisions.

During an LCD fabricating process, electrostatic charge may be generated in the LCD. If too much electrical charge builds up at any one location on the LCD, the built up electrical charge is liable to discharge, thereby damaging or destroying a driving integrated circuit (IC) of the LCD such as a gate IC or a data IC. Thus in a typical LCD, a plurality of electrostatic discharge units are employed. The electrostatic discharge units discharge any electrical charge in a timely manner during the fabricating process.

FIG. 4 is a schematic, abbreviated diagram of a layout of certain parts of a typical LCD. The LCD 10 includes a thin film transistor (TFT) substrate 2, a driving IC 3 disposed on a surface of the TFT substrate 2, a plurality of first conducting lines 6 disposed on the TFT substrate 2, and a flexible printed circuit board (FPCB) 4. The FPCB 4 includes a plurality of second conducting lines 43 (only one shown), an electrostatic discharge unit 45 formed thereon, and a system controlling circuit 47 formed thereon. Each of the first conducting lines 6 includes a first metal pad (not shown) connected to a corresponding input/output pin 31 of the driving IC 3, and a second metal pad (not shown) at an edge of the TFT substrate 2. Each of the second conducting lines 43 includes a third metal pad 41 connected to a corresponding one of the second metal pads. A first terminal of the electrostatic discharge unit 45 is connected to the driving IC 3 via one of the second conducting lines 43 and a corresponding first conducting line 6 in series. A second terminal of the electrostatic discharge unit 45 is connected to ground. A third terminal of the electrostatic discharge unit 45 is connected to the system controlling circuit 47. The system controlling circuit 47 is used to control the electrostatic discharge unit 45 in order to discharge electrostatic charge of the driving IC 3.

However, the electrostatic discharge unit 45 is positioned on the FPCB 4 and the driving IC 3 is positioned on the surface of the TFT substrate 2. An electrical discharge path formed by the driving IC 3, the first conducting line 6, the third metal pad 41, the second conducting line 43 and the electrostatic discharge unit 45 to ground is very long. Therefore, the electrostatic charge of the driving IC 3 may not be completely discharged to ground.

It is desired to provide an LCD which overcomes the above-described deficiencies.

### SUMMARY

In one preferred embodiment, an LCD includes a TFT substrate, a driving IC disposed on the TFT substrate, a FPCB connected to an edge of the TFT substrate, at least one electrostatic discharge unit provided on the TFT substrate, and a system controlling circuit. The TFT substrate includes a plurality of first conducting lines. Each first conducting line includes a first metal pads and a second metal pad at two opposite ends thereof respectively. The driving IC includes a plurality of input/output pins connected to the first metal pads respectively. The FPCB includes a plurality of second conducting lines connected to the first conducting lines via the second metal pads respectively. The at least one electrostatic discharge unit is located and electrically connected between one of the first metal pads and one of the second metal pads with the electrical connection being via a corresponding one of the first conducting lines, a terminal of the at least one electrostatic discharge unit is connected to ground for discharging any electrostatic charge of the driving IC. The system controlling circuit is connected to the driving IC via one of the second conducting lines, the corresponding first conducting line, and the at least one electrostatic discharge unit in series.

Advantages and novel features of the above-described LCD will become more apparent from the following detailed description when taken in conjunction with the accompanying drawings, in which:

### BRIEF DESCRIPTION OF THE DRAWINGS

FIG. 1 is a schematic, abbreviated diagram of a layout of certain parts of an LCD according to a first embodiment of the present invention, the LCD including a driving IC and an electrostatic discharge unit;

FIG. 2 is a circuit diagram of an electrical discharge path of FIG. 1, including details of the electrostatic discharge unit;

FIG. 3 is a schematic, abbreviated diagram of a layout of certain parts of an LCD according to a second embodiment of the present invention; and

FIG. 4 is a schematic, abbreviated diagram of a layout of certain parts of a conventional LCD.

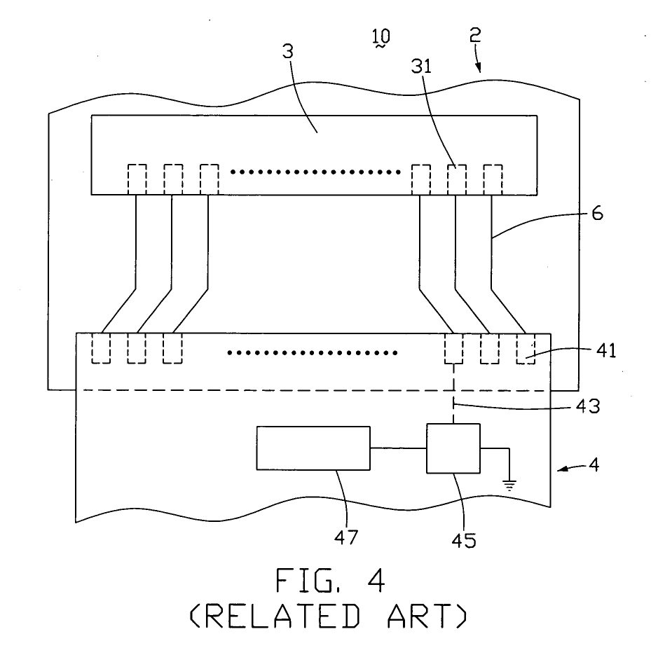

### DETAILED DESCRIPTION OF PREFERRED EMBODIMENTS

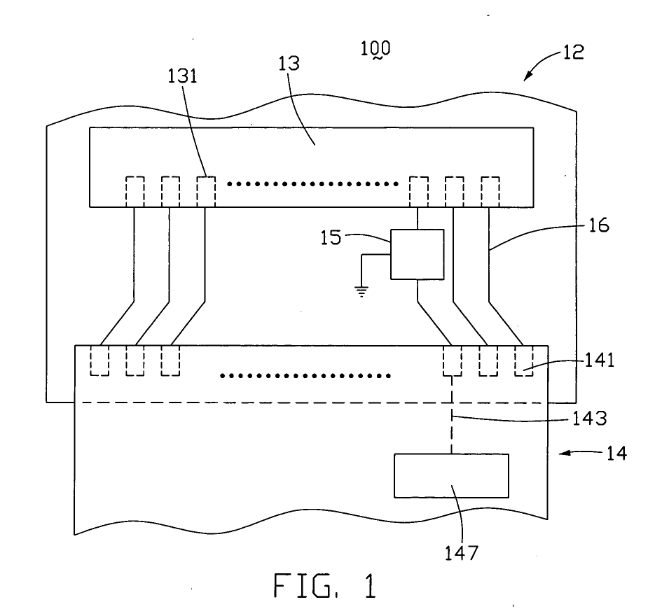

FIG. 1 is a schematic, abbreviated diagram of a layout of certain parts of an LCD according to a first embodiment of the present invention. The LCD 100 includes a TFT substrate 12, a driving IC 13 disposed on a surface of the TFT substrate 12, an electrostatic discharge unit 15 formed on the surface of the TFT substrate 12, a plurality of first conducting lines 16 disposed on the TFT substrate 12, and an FPCB 14. The FPCB 14 includes a plurality of second conducting lines 143 (only one shown), and a system controlling circuit 147 formed thereon. Each of the first conducting lines 16 includes a first metal pad (not shown) connected to a corresponding input/output pin 131 of the driving IC 13, and a second metal pad (not shown) at an edge of the TFT substrate 12. Each of the second conducting lines 143 includes a third metal pad 141 connected to a corresponding one of the second metal pads. The electrostatic discharge unit 15 is located and electrically connected between one of the first metal pads and one of the second metal pads, with the electrical connection being via a corresponding one of the first conducting lines 16. A terminal of the electrostatic discharge unit 15 is connected to ground or a power pin of the driving IC 13, for discharging any electrostatic charge of the driving IC 13. In the illustrated embodiment, this terminal of the electrostatic discharge unit 15 is connected to ground. The system controlling circuit 147 is connected to the driving IC 13 via at least one of the second conducting lines 143, the electrostatic discharge unit 15, and said corresponding first conducting line 16 in series. The system controlling circuit 147 is used to control the driving IC 13.

The electrostatic discharge unit 15 and the driving IC 13 are both formed on the surface of the TFT substrate 12. An electrical discharge path formed by the driving IC 13, said corresponding first conducting line 16, and the electrostatic discharge unit 15 to ground (or to the power pin of the driving IC 13) is relatively short in length. Therefore the electrostatic charge of the driving IC 13 can be completely discharged to ground (or to the power pin of the driving IC 13).

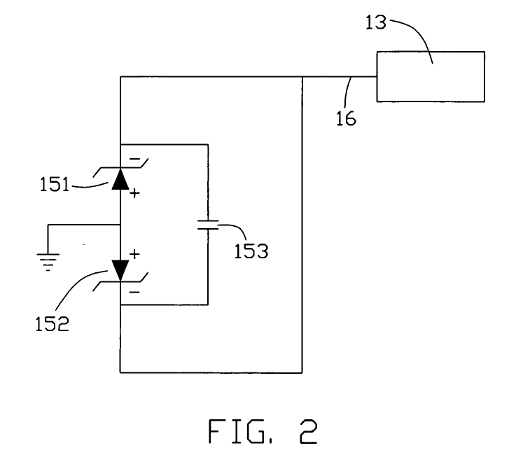

FIG. 2 is a circuit diagram of the electrical discharge path of the LCD 100, including details of the electrostatic discharge unit 15. The electrostatic discharge unit 15 includes a capacitor 153, and two diodes 151, 152. The positive terminals of the two diodes 151, 152 are connected to ground (or to the power pin of the driving IC 13), for discharging any electrostatic charge of the driving IC 13. In the illustrated embodiment, these positive terminals are connected to ground. The negative terminals of the two diodes 151, 152 are connected to the corresponding input/output pin 131 of the driving IC 13 via said corresponding conducting line 16. The capacitor 153 is connected between the two negative terminals of the two diodes 151, 152.

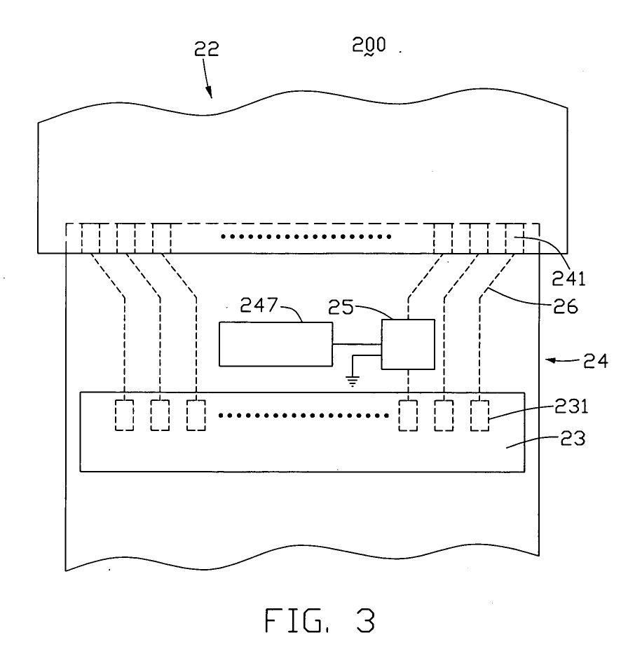

FIG. 3 is a schematic, abbreviated diagram of a layout of certain parts of an LCD according to a second embodiment of the present invention. The LCD 200 includes a thin film transistor (TFT) substrate 22, an FPCB 24 connected to an edge of the substrate 22, a driving IC 23 formed on a surface of the FPCB 24, an electrostatic discharge unit 25 formed on the surface of the FPCB 24, and a system controlling circuit 247 formed on the surface of the FPCB 24. The FPCB 24 includes a plurality of conducting lines 26. Each of the conducting lines 26 includes a first metal pad 241 at an end of the FPCB 24 that is connected to the TFT substrate 22, and a second metal pad (not shown) at an end of the conducting line 26 that is distal from the TFT substrate 22. The driving IC 23 includes a plurality of input/output pins 231. The input/output pins 231 of the driving IC 23 are connected to the second metal pads respectively. The electrostatic discharge unit 25 is located and electrically connected between one of the first metal pads 241 and a corresponding one of the second metal pads, with the electrical connection being via a corresponding one of the conducting lines 26. A terminal of the electrostatic discharge unit 25 is connected to ground or to a power pin of the driving IC 23, for discharging any electrostatic charge of the driving IC 23. In the illustrated embodiment, this terminal of the electrostatic discharge unit 25 is connected to ground. The system controlling circuit 247 is connected to the driving IC 23 via a conducting line (not labeled) connecting to the electrostatic discharge unit 25, the electrostatic discharge unit 25, and said corresponding first conducting line 26 in series. The system controlling circuit 247 is used to control the driving IC 23.

The electrostatic discharge unit 25 and the driving IC 23 are both formed on the surface of the FPCB 24. An electrical discharge path formed by the driving IC 23, said corresponding first conducting line 26, and the electrostatic discharge unit 25 to ground (or to the power pin of the driving IC 23) is relatively short in length. Therefore the electrostatic charge of the driving IC 23 can be completely discharged to ground (or to the power pin of the driving IC 23).

In an alternative embodiment, more than one of the input/output pins 131 of the driving IC 13 can also be connected to corresponding plural electrostatic discharge units 15 respectively. In another words, the LCD 100 can include a plurality of electrostatic discharge units 15, each of which is connected between a respective one of the input/output pins of the driving IC 13 and ground (or the power pin of the driving IC 13). Furthermore, the system controlling circuit 147 can instead be formed on the surface of the TFT substrate 12.

It is to be understood, however, that even though numerous characteristics and advantages of preferred embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. A liquid crystal display (LCD), comprising:
a thin film transistor (TFT) substrate comprising a plurality of first conducting lines, each first conducting line comprising a first metal pad and a second metal pad at two opposite ends thereof respectively;
a driving integrated circuit (IC) disposed on the TFT substrate, the driving IC comprising a plurality of input/output pins connected to the first metal pads respectively;
a flexible printed circuit board (FPCB) connected to an edge of the TFT substrate, the FPCB comprising a plurality of second conducting lines connected to the first conducting lines via the second metal pads respectively;
at least one electrostatic discharge unit provided on the TFT substrate, and located and electrically connected between one of the first metal pads and one of the second metal pads with the electrical connection being via a corresponding one of the first conducting lines, a terminal of the at least one electrostatic discharge unit being connected to ground for discharging any electrostatic charge of the driving IC; and
a system controlling circuit connected to the driving IC via one of the second conducting lines, the corresponding first conducting line, and the at least one electrostatic discharge unit in series.

2. The LCD as claimed in claim 1, wherein the system controlling circuit is provided on the FPCB.

3. The LCD as claimed in claim 1, wherein the at least one electrostatic discharge unit comprises a capacitor and two diodes, positive terminals of the diodes are connected to ground, negative terminals of the diodes are connected to a corresponding one of the input/output pins of the driving IC, and the capacitor is connected between the negative terminals of the diodes.

4. The LCD as claimed in claim 3, wherein the at least one electrostatic discharge unit is a plurality of electrostatic discharge units, and each of the electrostatic discharge units is connected between a respective one of the input/output pins of the driving IC and ground.

5. A liquid crystal display (LCD), comprising:
a thin film transistor (TFT) substrate;
a flexible printed circuit board (FPCB) connected to an edge of the TFT substrate, the FPCB comprising a plurality of conducting lines, each of the conducting lines comprising a first metal pad at an end thereof where the FPCB connects to the TFT substrate and a second metal pad at an opposite end thereof distal from the TFT substrate;
a driving IC provided on the FPCB, the driving IC comprising a plurality of input/output pins connected to the second metal pads respectively;
at least one electrostatic discharge unit provided on the FPCB, and located and electrically connected between one of the first metal pads and one of the second metal pads with the electrical connection being via a corresponding one of the conducting lines, a terminal of the at least one electrostatic discharge unit being connected to ground for discharging any electrostatic charge of the driving IC; and
a system controlling circuit connected to a corresponding one of the input/output pins of the driving IC via the at least one electrostatic discharge unit and the corresponding conducting lines in series.

6. The LCD as claimed in claim 5, wherein the system controlling circuit is provided on the FPCB.

7. The LCD as claimed in claim 5, wherein the at least one electrostatic discharge unit comprises a capacitor and two diodes, positive terminals of the diodes are connected to ground, negative terminals of the diodes are connected to the corresponding input/output pin of driving IC, and the capacitor is connected between the negative terminals of the diodes.

8. The LCD as claimed in claim 7, wherein the at least one electrostatic discharge unit is a plurality of electrostatic discharge units, and each of the electrostatic discharge units is connected between a respective one of the input/output pins of the driving IC and ground.

9. A liquid crystal display (LCD), comprising:
a thin film transistor (TFT) substrate comprising a plurality of first conducting lines, each first conducting line comprising a first metal pad and a second metal pad at two opposite ends thereof respectively;
a driving integrated circuit (IC) provided on the TFT substrate, the driving IC comprising a plurality of input/output pins connected to the first metal pads respectively;
a flexible printed circuit board (FPCB) connected to an edge of the TFT substrate, the FPCB comprising a plurality of second conducting lines connected to the first conducting lines via the second metal pads respectively;
at least one electrostatic discharge unit provided on the TFT substrate, and located and electrically connected between one of the first metal pads and one of the second metal pads with the electrical connection being via a corresponding one of the first conducting lines, a terminal of the at least one electrostatic discharge unit being connected to a power pin of the driving IC for discharging any electrostatic charge of the driving IC; and
a system controlling circuit connected to the driving IC via one of the second conducting lines, the corresponding first conducting line, and the at least one electrostatic discharge unit in series.

10. The LCD as claimed in claim 9, wherein the system controlling circuit is provided on the FPCB.

11. The LCD as claimed in claim 9, wherein the at least one electrostatic discharge unit comprises a capacitor and two diodes, positive terminals of the diodes are connected to the power pin of the driving IC, negative terminals of the diodes are connected to a corresponding one of the input/output pins of the driving IC, and the capacitor is connected between the negative terminals of the diodes.

12. The LCD as claimed in claim 11, wherein the at least one electrostatic discharge unit is a plurality of electrostatic discharge units, and each of the electrostatic discharge units is located and electrically connected between a respective one of the input/output pins of the driving IC and the power pin of the driving IC.
